(19) United States
(12) Patent Application Publication
(10) Pub. No.: US 2022/0200056 A1
(43) Pub. Date: Jun. 23, 2022

(54) SOLID-STATE BATTERY

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/644,097

(22) Filed: Dec. 14, 2021

(30) Foreign Application Priority Data
Dec. 17, 2020 (JP) 2020-209115

(51) Int. Cl. H01M 10/0585; H01M 10/0562; H01M 10/0525

(52) U.S. Cl. CPC H01M 10/0585; H01M 10/0525; H01M 10/0562

(57) ABSTRACT

To provide a solid-state battery that can improve layout by allowing a current collecting position to be optionally disposed and that can suppress the occurrence of short circuits. A solid-state battery includes a positive electrode, a negative electrode, and a solid electrolyte layer disposed between the positive electrode and the negative electrode. A first electrode selected from one of the positive electrode and the negative electrode includes a material mixture filled portion including a metal porous body filled with an electrode material mixture. The solid electrolyte layer is disposed so as to cover a periphery of the material mixture filled portion. A second electrode selected from the other of the positive electrode and the negative electrode is disposed so as to cover the solid electrolyte layer.

This application is based on and claims the benefit of priority from Japanese Patent Application No. 2020-209115, filed on 17 Dec. 2020, the content of which is incorporated herein by reference.

### BACKGROUND OF THE INVENTION

### Field of the Invention

The present invention relates to a solid-state battery.

### Related Art

Conventionally, lithium ion secondary batteries are widely used as secondary batteries having a high energy density. A lithium ion secondary battery is configured to include a positive electrode, a negative electrode, and a separator interposed therebetween, and to be filled with a liquid electrolyte.

Since the electrolytic solution of such a lithium ion secondary battery is usually a flammable organic solvent, some lithium ion secondary batteries pose a safety issue when exposed to heat, in particular. Therefore, solid-state batteries employing an inorganic solid electrolyte as an alternative to the organic liquid electrolyte have been proposed.

On the other hand, to increase the filling density of an electrode active material, it has been proposed to use a metal porous body as a current collector constituting positive and negative electrode layers instead of a metal foil that has been conventionally widely used (see Patent Document 1). The metal porous body has a network structure with pores and a large surface area. Filling the interior of said network structure with an electrode material mixture including an electrode active material enables the amount of the electrode active material per unit area of an electrode layer to be increased.

Patent Document 1: Japanese Unexamined Patent Application, Publication No. 2020-107441

### SUMMARY OF THE INVENTION

In conventional solid-state batteries, electrodes are stacked and connected in series to obtain the required voltage. Therefore, the extension direction of the current collecting tab is limited to a direction perpendicular to the direction in which the electrodes are stacked, which limits the layout of the battery. In addition, when a plurality of batteries are combined and stacked, the electrode layers contact each other, and thus a short circuit may occur.

In response to the above issues, it is an object of the present invention to provide a solid-state battery that can improve layout by allowing a current collecting position to be optionally disposed and that can suppress the occurrence of short circuits.

(1) A first aspect of the present invention relates to a solid-state battery, including a positive electrode, a negative electrode, and a solid electrolyte layer disposed between the positive electrode and the negative electrode. A first electrode selected from one of the positive electrode and the negative electrode includes a material mixture filled portion including a metal porous body filled with an electrode material mixture. The solid electrolyte layer is disposed so as to cover a periphery of the material mixture filled portion. A second electrode selected from the other of the positive electrode and the negative electrode is disposed so as to cover the solid electrolyte layer.

According to the invention of the first aspect, it is possible to provide a solid-state battery that can improve layout by allowing a current collecting position to be optionally disposed and that can suppress the occurrence of short circuits.

(2) A second aspect of the present invention relates to a solid-state battery, including a plurality of the solid-state batteries according to the first aspect combined together. The second electrodes of the plurality of the solid-state batteries are disposed in contact with each other.

According to the invention of the second aspect, the current collecting portion can be minimized and the energy density of the solid-state battery can be improved.

(3) In a third aspect of the present invention according to the first or second aspect, the second electrode has a current collecting portion disposed at least on a surface of the solid-state battery.

According to the invention of the third aspect, the layout of the solid-state battery can be improved by allowing the current collecting position to be optionally disposed, and the current collecting portion can be minimized. Thus, the energy density of the solid-state battery can be improved.

(4) In a fourth aspect of the present invention according to any one of the first to third aspects, the solid electrolyte layer is disposed so as to cover at least all faces other than a tab extension face of the first electrode.

According to the invention of the fourth aspect, it is possible to provide a solid-state battery that can improve layout by allowing the current collecting position to be optionally disposed and that can more preferably suppress the occurrence of short circuits.

### BRIEF DESCRIPTION OF THE DRAWINGS

FIG. 1 is a cross-sectional schematic diagram of a solid-state battery according to a first embodiment of the present invention;

FIG. 2 is a cross-sectional schematic diagram of a solid-state battery according to a second embodiment of the present invention; and

FIG. 3 is a cross-sectional schematic diagram of a solid-state battery according to a third embodiment of the present invention.

### DETAILED DESCRIPTION OF THE INVENTION

Embodiments of the present invention will now be described with reference to the drawings. However, the following embodiments exemplify the present invention, and the present invention is not limited to the following embodiments.

### First Embodiment

### <Overall Structure of Solid-State Battery>

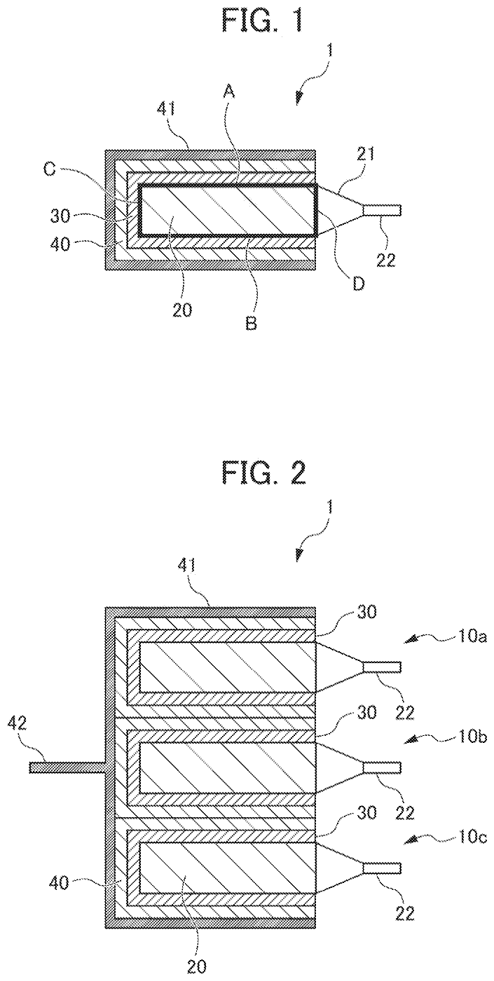

As shown in FIG. 1, a solid-state battery 1 of the present embodiment includes a positive electrode 20, a solid electrolyte layer 30, and a negative electrode 40. In the present embodiment, a tab convergence portion 21 that reduces in diameter and is connected to a tab portion 22, is formed on a tab extension face D of the positive electrode 20. The solid electrolyte layer 30 is provided so as to cover at least a face other than the above-described tab extension surface D of the positive electrode 20. Further, the negative electrode 40 is provided so as to cover the solid electrolyte layer 30. A current collecting portion 41 is disposed at least on the surface of the negative electrode 40. In this embodiment, the solid-state battery 1 will be described below as being a solid-state lithium ion secondary battery capable of charging and discharging by occluding and releasing lithium ions and electrons.

The electrode disposed on the inner side of the solid-state battery 1 is preferably a positive electrode, as in the present embodiment, but the electrode disposed on the inner side may be a negative electrode. The electrode disposed on the inner side, which is any one of the positive electrode and the negative electrode, includes a metal porous body as a current collector filled with an electrode material mixture. The electrode disposed on the outer surface of the solid-state battery 1 is formed in the form of a layer on the surface of the solid electrolyte layer 30, and a current collecting portion such as a metal foil is disposed at least on the surface of the electrode. The structure of the solid-state battery 1 will be described, assuming that the electrode disposed on the inner side of the solid-state battery 1 is the positive electrode 20 and that the electrode formed on the outer surface is the negative electrode 40.

(Positive Electrode)

The positive electrode 20 includes a metal porous body having pores that are continuous with each other as a current collector, and a part of the metal porous body is filled with a positive electrode material mixture. As shown in FIG. 1, in the positive electrode 20, the tab convergence portion 21 that reduces in diameter and is connected to the tab portion 22, is formed on the tab extension face D. The tab convergence portion 21 and the tab portion 22 are not filled with an electrode material mixture. The tab portion 22 is electrically connected to a lead tab (not shown) by welding or the like. The portion of the positive electrode 20 other than the tab convergence portion 21 and the tab portion 22 is a material mixture filled portion that is filled with a positive electrode material mixture.

(Solid Electrolyte Layer)

The solid electrolyte layer 30 includes at least a solid electrolyte material that is a solid or gel electrolyte. Charge transfer between a positive electrode active material and a negative electrode active material can be performed through the above solid electrolyte material. The solid electrolyte layer 30 is formed in the form of a layer so as to cover the material mixture filled portion of the positive electrode 20. The solid electrolyte layer 30 is disposed so as to cover at least any one of stacked faces A, B, and C in FIG. 1. As shown in FIG. 1, in this embodiment, the solid electrolyte layer 30 covers at least all faces of the positive electrode 20 other than the tab extension face D on which the tab convergence portion 21, to which the tab portion 22 is connected, is formed. That is, the stacked faces A, B, and C other than the tab extension face D of the positive electrode 20 in FIG. 1, are covered by the solid electrolyte layer 30. This prevents a short circuit from occurring when the material mixture filled portion of the positive electrode 20 contacts the other electrode. In particular, this structure is effective in the following case: when a metal porous body is used as a current collector, the electrode becomes thicker and thus a short circuit is likely to occur in a stacked face of the electrode. In addition, the solid electrolyte layer 30 may be formed on a part of the tab extension face D. For example, the solid electrolyte layer 30 may be formed on a part or all of the surface of the tab convergence portion 21. This prevents a short circuit caused by the tab convergence portion 21. The solid electrolyte layer 30 may be formed on parts of the tab extension face D other than the welding point with the lead tab in the tab portion 22.

The solid electrolyte material is not limited. Examples of the solid electrolyte material include a sulfide solid electrolyte material, an oxide solid electrolyte material, a nitride solid electrolyte material, and a halide solid electrolyte material.

(Negative Electrode)

The negative electrode 40 is disposed so as to cover the solid electrolyte layer 30. The current collecting portion 41 is disposed at least on the surface of the solid-state battery 1. The current collecting portion 41 such as a metal foil is configured to conduct current to a current collector constituting the negative electrode 40. This structure enables current collection from any face of the solid-state battery 1 other than the face to which the tab portion 22 is electrically connected, thus improving the layout of the solid-state battery 1.

Even if the electrode is exposed and contacts a metal part or the like that constitutes the solid-state battery module structure, the disposition of the negative electrode 40 on the outer surface of the solid-state battery 1 suppresses the metal part or the like from corroding, because the negative electrode of low potential is disposed on the outermost surface. If the positive electrode is disposed on the outermost surface, the solid-state battery module structure itself will come to have a high voltage when the positive electrode contacts the metal part or the like. Thus, moisture in the air is decomposed in the metal part, which may cause corrosion of the metal. Further, since the current collecting portion 41 composed of a metal foil or the like is disposed on the surface of the negative electrode 40, it is difficult for moisture to reach the solid electrolyte layer 30. This can inhibit the generation of hydrogen sulfide or the like when moisture contacts the solid electrolyte material, thus improving the safety of the solid-state battery 1.

(Current Collector)

The positive electrode 20 includes a metal porous body having pores that are continuous with each other. Since the metal porous body has pores that are continuous with each other, it is possible to fill the pores with a positive electrode material mixture including an electrode active material, thereby increasing the amount of the electrode active material per unit area of the electrode layer. The metal porous body is not limited as long as it has pores that are continuous with each other. Examples of the form of the metal porous body include a foam metal having pores by foaming, a metal mesh, an expanded metal, a punching metal, and a metal nonwoven fabric.

The metal used in the metal porous body is not limited as long as it has electric conductivity. Examples thereof include nickel, aluminum, stainless steel, titanium, copper, and silver. Among these, as the current collector constituting the positive electrode 20, a foamed aluminum, foamed nickel, and foamed stainless steel are preferable. As the current collector constituting the negative electrode 40 when the negative electrode is disposed on the inner side, a foamed copper and foamed stainless steel are preferable. The use of the metal porous body as the current collector allows the amount of the active material per unit area of the electrode to be increased, and thus the volumetric energy density of the solid-state battery can be improved. In addition, since the positive and negative electrode material mixtures are easily fixed, it is not necessary to thicken a coating slurry for forming the electrode material mixture layer when a film of the electrode material mixture layer is thickened, unlike a conventional electrode using a metal foil as a current collector. Therefore, it is possible to reduce a binder such as an organic polymer compound that has been necessary for thickening. Accordingly, the capacity per unit area of the electrode can be increased, and a higher capacity of the solid-state battery can be achieved.

The current collecting portion 41 constituting the negative electrode 40 is not limited. Examples thereof include a thin plate of nickel, copper, and stainless steel. When the positive electrode is disposed on the outer side, the current collecting portion constituting the positive electrode is not limited. Examples thereof include a thin plate of aluminum, aluminum alloy, stainless steel, nickel, iron, and titanium.

(Electrode Material Mixture, Electrode Layer)

The positive electrode material mixture constituting the positive electrode 20 is disposed in pores formed within a metal porous body as a current collector. The negative electrode 40 is obtained by forming a slurry including an electrode active material in the form of a layer. The positive electrode material mixture and the negative electrode layer formed in the form of a layer respectively include a positive electrode active material and a negative electrode active material as an essential component.

(Electrode Active Material)

The positive electrode active material is not limited as long as it can occlude and release lithium ions. Examples thereof include LiCoO₂, Li (Ni_{5/10}Co_{2/10}Mn_{3/10}) O₂, Li (Ni_{6/10}Co_{2/10}Mn_{2/10}) O₂, Li (Ni_{8/10}Co_{1/10}Mn_{1/10}) O₂, Li (Ni_{0.8}Co_{0.15}Al_{0.05}) O₂, Li (Ni_{1/6}Co_{4/6}Mn_{1/6}) O₂, Li (Ni_{1/3}Co_{1/3}Mn_{1/3}) O₂, Li (Ni_{1/3}Co_{1/3}Mn_{1/3}) O₂, LiCoO₄, LiMn₂O₄, LiNiO₂, LiFePO₄, lithium sulfide, and sulfur.

The negative electrode active material is not limited as long as it can occlude and release lithium ions. Examples thereof include metallic lithium, lithium alloys, metal oxides, metal sulfides, metal nitrides, Si, SiO, and carbon materials such as artificial graphite, natural graphite, hard carbon, and soft carbon.

(Other Components)

The electrode material mixture and the electrode layer may optionally include other components other than the electrode active material. The other components are not limited, and can be any components that can be used in making a lithium ion secondary battery. Examples thereof include a conductivity aid and a binder. Acetylene black is an example of the conductivity aid of the positive electrode, and polyvinylidene fluoride is an example of the binder of the positive electrode. Examples of the binder of the negative electrode include sodium carboxyl methyl cellulose, styrene-butadiene rubber, and sodium polyacrylate.

### <Method for Manufacturing Solid-State Battery 1>

A method for manufacturing the solid-state battery 1 includes a material mixture filling step of filling the pores of a metal porous body as a current collector with an electrode material mixture to form the positive electrode 20, a first pressing step of pressing the positive electrode 20 by roll pressing or the like, a solid electrolyte layer formation step of forming the solid electrolyte layer 30 on the surface of the positive electrode 20, and a negative electrode formation step of forming the negative electrode 40 on the surface of the solid electrolyte layer 30, and a second pressing step of pressing the entire battery to integrate the components into a whole.

The method of filling the current collector with the electrode material mixture in the material mixture filling step is not limited. Examples thereof includes the method of filling the pores of the current collector with a slurry including the electrode material mixture by applying pressure using a plunger-type die coater, and the method of impregnating the pores of the metal porous body with the electrode material mixture by a dipping method.

The first pressing step is a step of pressing the positive electrode 20 by roll pressing or the like after the positive electrode 20 is formed by the above-described material mixture filling step. The tab convergence portion 21 and the tab portion 22 are formed by the first pressing step.

The solid electrolyte layer formation step is not limited. A slurry including a solid electrolyte material may be coated on the surface of the positive electrode 20, or a solid electrolyte layer formed in the form of a sheet may be attached to the surface of the positive electrode 20.

The negative electrode formation step is not limited, and is performed, for example, by coating a slurry including a negative electrode active material onto the surface of the solid electrolyte layer 30.

The second pressing step is a step of pressing the solid-state battery 1 in the same manner as the first pressing step. The second pressing step can improve the density of the electrode material mixture, and can adjust the density to a desired density.

Other embodiments of the present invention are described below. Description of the same structure as that of the first embodiment may be omitted.

### Second Embodiment

### <Overall Structure of Solid-State Battery>

As shown in FIG. 2, the solid-state battery 1 according to this embodiment includes three solid-state batteries 10a, 10b, and 10c combined together. The individual structures of the three solid-state batteries 10a, 10b, and 10c are the same as the solid-state battery 1 of the first embodiment, except for the structure of the current collector 41.

As shown in FIG. 2, the negative electrode 40 of the solid-state battery 10a and the negative electrode 40 of the solid-state battery 10b are disposed in contact with each other. Similarly, the negative electrode 40 of the solid-state battery 10b and the negative electrode 40 of the solid-state battery 10c are disposed in contact with each other. The solid-state batteries 10a, 10b, and 10c have a common current collecting portion 41. The current collecting portion 41 has a tab portion 42. As a result, the negative electrodes 40 of the solid-state batteries 10a, 10b, and 10c are electrically connected to each other. On the other hand, the tab portions 22 electrically connected to the positive electrodes 20 of the solid-state batteries 10a, 10b, and 10c are electrically connected to lead tabs (not shown), respectively. With the above structure, the solid-state batteries 10a, 10b, and 10c are connected in parallel.

In this embodiment, the current collecting portion 41 is disposed only on the outer surface of the solid-state battery 1. The collecting portion 41 may be disposed between each adjacent battery of a plurality of solid-state batteries, but is preferably disposed only on the outer surface of the solid-state battery 1. This enables the current collecting portion 41 to be minimized and the energy density of the solid-state battery 1 to be improved.

In the solid-state battery 1 according to the present embodiment, in FIG. 2, the face on which the tab portion 42 is disposed is opposite to the face to which the tab portions 22 are electrically connected, but the present invention is not limited to this structure. The face on which the tab portion 42 is disposed can be any face other than the tab extension face to which the tab portions 22 are electrically connected. This can improve the layout of the solid-state battery 1.

### <Method for Manufacturing Solid-State Battery 1>

The method for manufacturing the solid-state battery 1 according to the present embodiment includes the second pressing step of pressing the entire battery after optionally stacking a plurality of solid-state batteries 10a, 10b, and 10c. Thus, in the plurality of solid-state batteries, the adjacent negative electrodes 40 are brought into close contact with each other and integrated.

### Third Embodiment

<Overall Structure of Solid-State Battery 1a>

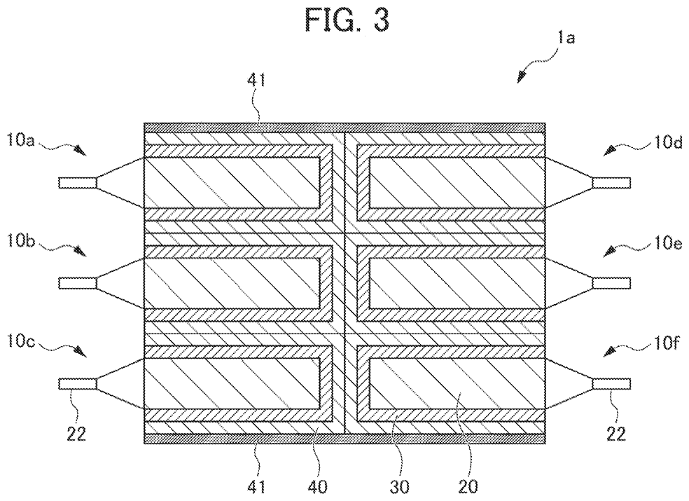

As shown in FIG. 3, a solid-state battery 1a according to this embodiment includes six solid-state batteries 10a, 10b, 10c, 10d, 10e, and 10f combined together. The individual structures of the above six solid-state batteries are the same as those of the solid-state batteries 1 according to the first and second embodiments, except for the structure of the current collecting portion 41.

As shown in FIG. 3, adjacent negative electrodes 40 of the six solid-state batteries 10a, 10b, 10c, 10d, 10e, and 10f are disposed in contact with each other. The above six solid-state batteries have common current collecting portions 41. On the other hand, the tab portions 22 electrically connected to the positive electrodes 20 of the six solid-state batteries, are electrically connected to lead tabs (not shown), respectively. With this structure, the six solid-state batteries are connected in parallel.

In this embodiment, the current collecting portion 41 may have a tab portion on any face other than the faces to which the tab portions 22 are electrically connected.

As shown in FIG. 3, in this embodiment, a solid-state battery consisting of the six solid-state batteries is constructed by joining together in a horizontal direction two stacked bodies each composed of three batteries stacked in a vertical direction. A conventional solid-state battery can only be constructed by stacking the electrodes and electrolyte layers in one direction, which limits the installation space of the battery to secure the required voltage and capacity. The solid-state battery according to this embodiment is advantageous in that the solid-state batteries can be stacked in any direction and connected, which improves the layout of the battery and allows the battery to be installed in locations where the battery could not previously be installed. For example, the solid-state battery 1a according to this embodiment can be preferably applied in applications such as automotive applications where the installation space of the battery is limited.

Preferred embodiments of the present invention have been described above. The present invention is not limited to the above embodiments and can be modified as appropriate.

### EXPLANATION OF REFERENCE NUMERALS

1, 1a solid-state battery
20 positive electrode (first electrode)
30 solid electrolyte layer
40 negative electrode (second electrode)
41 current collecting portion
D tab extension face

What is claimed is:

1. A solid-state battery, comprising:
a positive electrode;
a negative electrode; and
a solid electrolyte layer disposed between the positive electrode and the negative electrode,
a first electrode selected from one of the positive electrode and the negative electrode comprising a material mixture filled portion comprising a metal porous body filled with an electrode material mixture,
the solid electrolyte layer being disposed so as to cover a periphery of the material mixture filled portion, and
a second electrode selected from the other of the positive electrode and the negative electrode being disposed so as to cover the solid electrolyte layer.

2. A solid-state battery, comprising a plurality of the solid-state batteries according to claim 1 combined together,
wherein the second electrodes of the plurality of the solid-state batteries are disposed in contact with each other.

3. The solid-state battery according to claim 1, wherein the second electrode has a current collecting portion disposed at least on a surface of the solid-state battery.

4. The solid-state battery according to claim 1, wherein the solid electrolyte layer is disposed so as to cover at least all faces other than a tab extension face of the first electrode.
